(19) United States
(12) Patent Application Publication
(10) Pub. No.: US 2021/0335112 A1
(43) Pub. Date: Oct. 28, 2021

(54) CASH PROCESSING DEVICE

(71) Applicant: Oki Electric Industry Co., Ltd., Tokyo (JP)

(72) Inventor: Kiyoshi UEMATSU, Tokyo (JP)

(73) Assignee: Oki Electric Industry Co., Ltd., Tokyo (JP)

(21) Appl. No.: 17/312,850

(22) PCT Filed: Oct. 17, 2019
(86) PCT No.: PCT/JP2019/040890

§ 371 Date: Jun. 10, 2021

(30) Foreign Application Priority Data
Dec. 19, 2018 (JP) 2018-237730

(51) Int. Cl. G08B 15/02; G07D 9/00; G07D 11/225

(52) U.S. Cl. CPC G08B 15/02; G07D 11/225; G07D 9/00

(57) ABSTRACT

A cash processing device including: one or more medium holder units, each medium holder unit including a depository and a liquid spray mechanism configured to spray liquid onto mediums held in the depository; one or more spray controllers, each spray controller capable of reading unique identification information associated with the one or more medium holder units, and including a controller configured to control operation of a corresponding liquid spray mechanism based on a wireless signal from a first wireless communication section; and a system controller including a state controller that monitors occurrence of an abnormal state based on an input detection signal, and a second wireless communication section that uses the unique identification information acquired from each of the spray controllers to wirelessly communicate a control signal related to liquid spraying in response to a monitoring outcome.

### TECHNICAL FIELD

The present disclosure relates to a cash processing device, and may for example be applied to a cash processing device including a function to render banknotes unusable by spraying liquid thereon.

### BACKGROUND ART

Conventional cash processing devices that handle cash include, for example, cash processing devices provided with an antitheft ink system configured to spray a liquid such as ink onto the cash (for example banknotes) held inside the cash processing device, in order to stain and therefore render the cash unusable if an attempt is made to steal the cash (see Japanese Patent Application Laid-Open (JP-A) No. 2006-039775 and JP-A No. 2005-267573, and European Patent Application No. 1624426).

Various systems have been applied as antitheft ink systems. For example, FIG. 6 illustrates as a widely seen configuration in which a first control device 91 serving as a master section, second control devices 92 serving as subsidiary sections, and a sensor 93 are provided inside a cash processing device 1-1 that handles cash.

The first control device 91 includes a control means that controls functionality of the antitheft ink system, and a wireless communication means. The first control device 91 functions as a master section to the subsidiary sections configured by the second control devices 92. The first control device 91 is connected to the sensor 93 that detects a state of a safe door of the cash processing device 1-1 (such as an open or closed state of the safe door), or the occurrence of vibration, heat, deformation, tilting, gas, or the like. The first control device 91 monitors a state of the cash processing device 1-1 based on a sensor signal (physical information) from the sensor 93.

Based on the sensor signal, in a case in which the cash processing device 1-1 is in a non-abnormal state (and in a spray forbidden state), the first control device 91 wirelessly transmits a control signal including an ink spray command to cause the second control devices 92 to transition to an ink spray authorized state.

The second control devices 92 are provided to the respective cash holder units 11 (11-1, 11-2) loaded into the cash processing device 1-1. Each of the cash holder units 11 is provided with an ink spray mechanism (not illustrated in the drawings) configured to spray ink onto the cash held therein. Each of the second control devices 92 includes a controller that controls actuation of the corresponding ink spray mechanism, and a wireless communication section.

The second control devices 92 receive a wireless signal transmitted wirelessly from the first control device 91, and transition to either an ink spray forbidden state or an ink spray authorized state based on this control signal. When in the ink spray authorized state, the second control devices 92 independently acquire a sensor signal from the sensor 93, and control ink spraying based on a physical quantity detected by the sensor 93.

### SUMMARY OF INVENTION

### Technical Problem

In many conventional antitheft ink systems, the first control device 91, the second control devices 92, and the sensor 93 are external devices that are attached to the cash processing device as additional components.

In a case in which a separate cash processing device 1-2 is installed near to the cash processing device 1-1, a wireless signal transmitted by the first control device 91 of the cash processing device 1-1 may be received by second control devices 92 of the separate cash processing device 1-2, causing ink to be accidentally sprayed in the separate cash processing device 1-2.

For example, in a case in which an operation has been performed to exchange the cash holder units 11 in the cash processing device 1-1, due to this exchange taking place, a wireless signal from one of the second control devices 92 might be received by the cash processing device 1-1. There is accordingly a concern that subsequent ink spraying in the cash holder units 11 of the cash processing device 1-1 would be controlled by the second control device 92. In a case in which the operation to exchange the cash holder units 11 in the cash processing device 1-1 has been performed, a situation might therefore arise of, for example, the first control device 91 of the separate cash processing device 1-1 accidentally transitioning to an ink spray authorized state and of ink being accidentally sprayed in the separate cash processing device 1-1 as well when the second control device 92 in the cash processing device 1-2 has wirelessly transmitted a control signal to an ink spray authorized state. This would result in cash (banknotes) being unnecessarily rendered unusable.

The present disclosure provides a cash processing device that may prevent accidental spraying of liquid by a liquid spray mechanism.

### Solution to Problem

A first aspect according to the present disclosure is a cash processing device including (1) one or more medium holder units, each medium holder unit including a depository and a liquid spray mechanism configured to spray liquid onto mediums held in the depository, (2) one or plural spray controllers, each provided in association with a corresponding medium holder unit out of the one or plural medium holder units, and including a memory section configured to store unique identification information, a controller configured to control operation of the corresponding liquid spray mechanism, and a first wireless communication section, and (3) a system controller including a management section configured to manage the unique identification information acquired from each of the spray controllers, a state controller configured to monitor occurrence of an abnormal state based on an input detection signal, and a second wireless communication section configured to use the unique identification information to wirelessly communicate a control signal related to liquid spraying in response to a monitoring outcome.

### Advantageous Effects of Invention

According to the above aspect, a cash processing device of the present disclosure may prevent accidental spraying of liquid by a liquid spray mechanism.

### BRIEF DESCRIPTION OF DRAWINGS

FIG. 1 is a block diagram illustrating an internal configuration of a cash processing device according to an exemplary embodiment.

FIG. 2 is a configuration diagram illustrating an example of a correspondence table (1) according to an exemplary embodiment.

FIG. 3 is a configuration diagram illustrating an example of a correspondence table (2) according to an exemplary embodiment.

FIG. 4 is a sequence chart illustrating processing operations of a cash processing device 1 according to an exemplary embodiment.

FIG. 5 is an explanatory diagram for explaining state transition by a spray controller 22 according to an exemplary embodiment.

FIG. 6 is an explanatory diagram for explaining a configuration of a conventional antitheft ink system.

### DESCRIPTION OF EMBODIMENTS

### (A) Exemplary Embodiment

Detailed description follows regarding an exemplary embodiment of a cash processing device according to the present disclosure, with reference to the drawings.

(A-1) Configuration of Exemplary Embodiment

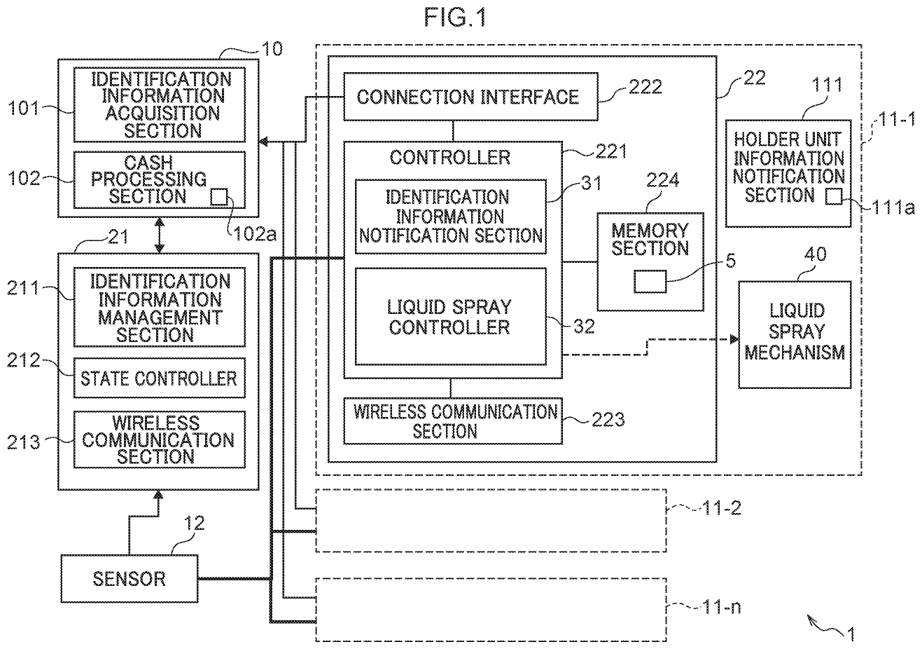

FIG. 1 is a block diagram illustrating an internal configuration of a cash processing device according to the present exemplary embodiment.

FIG. 1 illustrates a cash processing device 1 according to the present exemplary embodiment, including a cash processing controller 10, one or plural cash holder units 11 (11-1 to 11-n, wherein n is a positive integer), a system controller 21, one or plural spray controllers 22, and a sensor 12. Note that the cash processing device 1 may include a back-up power source (not illustrated in the drawings) for actuating antitheft ink system processing when an abnormal situation has arisen.

Cash Processing Controller 10

The cash processing controller 10 is a processing section or device that oversees cash processing in the cash processing device 1. The cash processing controller 10 includes an identification information acquisition section 101 and a cash processing section 102.

The identification information acquisition section 101 acquires unique identification information 5 from each of the spray controllers 22 associated with the corresponding cash holder units 11-1 to 11-n, described later. Note that the unique identification information 5 includes at least identification information that enables the individual cash holder unit 11 to be identified.

The cash processing section 102 performs predetermined cash processing relating to cash held in the respective cash holder units 11, described later. The cash processing section 102 includes a memory section 102a that stores information regarding cash processing, and performs cash processing as appropriate while referencing information stored in the memory section 102a.

The information stored in the memory section 102a may for example include information 111a relating to each of the cash holder units 11 (such as identification information, denomination of held banknotes, purpose of the cash holder unit, and the number of banknotes held at the time the cash holder unit 11 was loaded), the unique identification information 5 for each of the spray controllers 22, the number of banknotes currently being held in each of the cash holder units 11, and information regarding whether each of the cash holder units 11 is full.

Cash Holder Units 11

The cash holder units 11 (11-1 to 11-n) hold cash. The present exemplary embodiment principally envisages a case in which the cash is in the form of banknotes.

Each of the cash holder units 11-1 to 11-n has the same basic functionality. In FIG. 1, only the internal configuration of the cash holder unit 11-1 from out of the cash holder units 11-1 to 11-n is illustrated.

There is no particular limitation to the way in which cash is held in the respective cash holder units 11, and a wide range of approaches may be adopted. For example, each of the cash holder units 11 may include a box shaped depository, with banknote bundles held in the depository in a state in which their short edges run upright along an up-down direction (what is referred to as a sideways stacked state). Alternatively, banknote bundles may be stacked in the depository of the cash holder unit 11 in a state in which their surfaces face the up-down direction (what is referred to as a vertically stacked state).

Configuration may be made such that a single cash holder unit 11 holds only banknotes of the same denomination, or such that a single cash holder unit 11 holds banknotes of plural denominations. As another example, the cash processing device 1 may include a classification section that classifies banknote states (such as whether the banknote is genuine or counterfeit, dirty, or torn), with banknotes that have been rejected by the classification section being held in one of the cash holder units 11.

Each of the cash holder units 11 is capable of being attached to and detached from the cash processing device 1. For example, a stowing mechanism to enable the respective cash holder units 11 to be loaded into or removed from a stowage area of the cash processing device 1 may be provided in the stowage area where the respective cash holder units 11 are stowed inside the cash processing device 1.

As illustrated in FIG. 1, each of the cash holder units 11 includes a holder unit information notification section 111. The information 111a relating to the cash holder unit 11 is recorded in the holder unit information notification section 111, such that when the cash holder unit 11 is loaded into the cash processing device 1, the holder unit information notification section 111 notifies the cash processing controller 10 of the information 111a relating to the cash holder unit 11. The cash processing controller 10 is therefore able to manage the information 111a relating to each of the cash holder units 11 that has been loaded into the cash processing device 1. The information 111a relating to the cash holder unit 11 may include holder unit identification information for the cash holder unit 11, and information regarding the banknote denomination and number of banknotes held in the cash holder unit 11; however, there is no limitation thereto.

Each of the cash holder units 11 is provided with a liquid spray mechanism 40. The liquid spray mechanism 40 is configured to spray a liquid (such as an ink) onto the banknotes held in the cash holder unit 11 in response to a command from the spray controller 22. Thus, when an abnormal situation, such as the cash processing device 1 being broken into in an attempt to steal the cash, has arisen, the banknotes held inside the cash holder units 11 can be stained so as to render the banknotes unusable. Staining the banknotes enables the theft to be more easily exposed and the person using the stained banknotes to be more easily identified if there is an attempt to use the stolen banknotes.

Spray Controller 22

The spray controller 22 commands the liquid spray mechanism 40 to spray liquid under the control of the system controller 21, described later, when an abnormal situation has arisen.

The spray controller 22 is provided associated with the corresponding cash holder unit 11 including the liquid spray mechanism 40. Note that, being provided associated with the corresponding cash holder unit 11 is a concept encompassing both cases in which, the spray controller 22 is provided to a casing of the cash holder unit 11, and cases in which the spray controller 22 is provided to a loading area of the cash processing device 1 into which the corresponding cash holder unit 11 is loaded. In either case, each cash holder unit 11 including a liquid spray mechanism 40 is provided with a spray controller 22.

As illustrated in FIG. 1, the spray controller 22 includes a controller 221, a connection interface 222, a wireless communication section 223, and a memory section 224.

A hardware configuration of the spray controller 22 includes a CPU, ROM, RAM, EEPROM, an input/output interface, a communication device, and the like. The CPU executes a processing program (such as a spray control program) held in the ROM to implement the various functions of the spray controller 22.

The unique identification information 5 is stored in the memory section 224. Non-volatile memory may be employed as the memory section 224.

As previously described, the unique identification information 5 includes at least identification information that enables the corresponding cash holder unit 11 to be individually identified. As also previously described, identification information regarding the corresponding cash holder unit 11 is included in the information 111a relating to this cash holder unit 11, and this identification information regarding the cash holder unit 11 may be the same as the unique identification information 5. In order to aid understanding, in the present exemplary embodiment an example is given in which the unique identification information 5 is separate to the identification information relating to the cash holder unit 11 included in the information 111a.

The controller 221 oversees functionality of the spray controller 22. The controller 221 includes an identification information notification section 31 and a liquid spray controller 32.

The identification information notification section 31 notifies the cash processing controller 10 of the unique identification information 5 stored in the memory section 224 through the connection interface 222. This enables the cash processing controller 10 to be informed of the unique identification information 5 for the spray controller 22 provided to the corresponding cash holder unit 11.

As described later, the system controller 21 that controls an antitheft ink system coordinates with the cash processing controller 10, such that the system controller 21 is also able to ascertain the unique identification information 5 for each of the cash holder units 11. The system controller 21 accordingly uses the unique identification information 5 as transmission destination address information for the corresponding spray controller 22, thereby enabling the system controller 21 to wirelessly transmit signals such as a control signal including a spray forbidden command or a spray authorization command to a specific spray controller 22. This may enable accidental spraying of liquid in another nearby cash processing device 1 to be prevented.

The timing at which the cash processing controller 10 is notified of the unique identification information 5 may be the timing at which the corresponding cash holder unit 11 is loaded into the cash processing device 1. This enables the unique identification information 5 to be ascertained by both the cash processing controller 10 and the system controller 21 at an initial timing at which the cash holder unit 11 provided with the spray controller 22 is loaded into the cash processing device 1.

The timing of this notification is not limited to the above example, and may be a timing at which the cash holder unit 11 is temporarily removed and then reloaded into the cash processing device 1 when banknotes are being replenished in or removed from the cash holder unit 11. The unique identification information 5 may be notified at such a timing. In other words, the unique identification information 5 may be notified at a timing when the cash holder unit 11 is loaded into the cash processing device 1.

The liquid spray controller 32 acquires a control signal from the system controller 21 through the wireless communication section 223, and causes the spray controller 22 to transition between a spray forbidden state and a spray authorized state in response to this control signal.

In a case in which the spray authorized state is in effect and a physical quantity included in a sensor signal from the sensor 12 has exceeded a threshold such that a spray determination outcome is that liquid should be sprayed, the liquid spray controller 32 commands the liquid spray mechanism 40 to spray liquid. Note that, in a case in which a forbidden state is in place and a physical quantity included in the sensor signal from the sensor 12 is the threshold or below, the liquid spray controller 33 does not command the liquid spray mechanism 40 to spray liquid. Namely, a stand-by state is adopted.

The connection interface 222 is an interface that is connected to the cash processing controller 10 over a wired line, and that is controlled by the controller 221 to notify the cash processing controller 10 of the unique identification information 5 stored in the memory section 224.

The wireless communication section 223 performs wireless communication with a wireless communication section 213 of the system controller 21. There is no particular limitation to the wireless communication method employed by the wireless communication section 223, and a wireless communication method such as a IEEE 802.11n/ac/ax protocol (also known as WiFi (registered trademark)), or a short-range wireless communication method such as a IEEE 802.15.4 protocol (also known as Zigbee (registered trademark)) or Bluetooth (registered trademark), or the like may be employed therefor.

System Controller 21

The system controller 21 is a processing section or device that oversees processing relating to the antitheft ink system. The system controller 21 is connected to the sensor 12, and monitors whether or not an abnormal situation has arisen in the cash processing device 1 based on a sensor signal from the sensor 12. The system controller 21 transmits a wireless signal including a control signal to each of the spray controllers 22 provided to the respective cash holder units 11 according to a monitoring outcome based on the sensor signal from the sensor 12.

The system controller 21 is connected to the cash processing controller 10, acquires information relating to cash processing managed by the cash processing controller 10, and controls the antitheft ink system processing while coordinating with the cash processing controller 10.

As illustrated in FIG. 1, the system controller 21 includes an identification information management section 211, a state controller 212, and the wireless communication section 213.

A hardware configuration of the system controller 21 includes a CPU, ROM, RAM, EEPROM, an input/output interface, a communication device, and the like. The CPU executes a processing program (such as an antitheft ink system processing program) held in the ROM to implement the various functions of the system controller 21.

The identification information management section 211 acquires the unique identification information 5 for each of the spray controllers 22 and the identification information for the corresponding cash holder units 11 from the cash processing controller 10, and creates a correspondence table in which the unique identification information 5 for each spray controller 22 and the identification information for the cash holder unit 11 provided with this spray controller 22 are associated with each other. This enables the spray controllers 22 and the corresponding cash holder units 11 to be managed in association with each other.

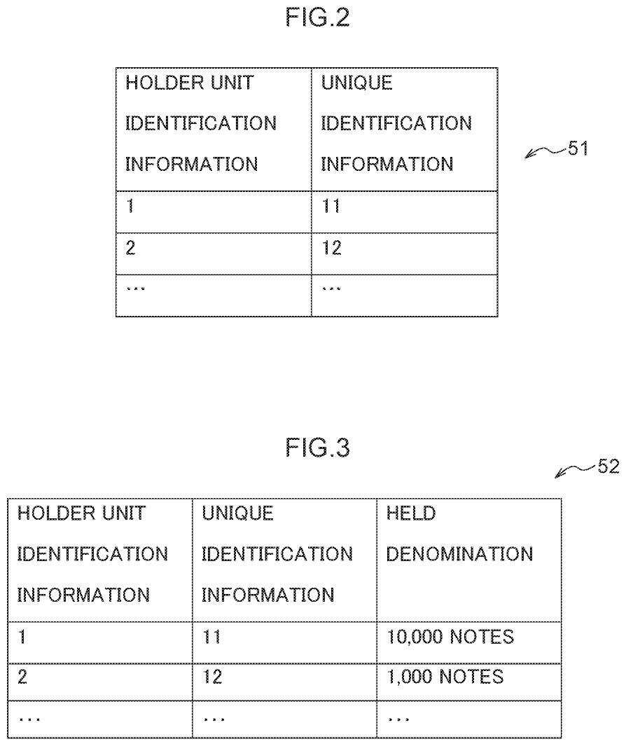

FIG. 2 is a configuration diagram illustrating an example of a correspondence table 51 according to the present exemplary embodiment. As illustrated in FIG. 2, such a correspondence table enables the identification information for each of the cash holder units 11 (holder unit identification information) and the unique identification information 5 for the corresponding spray controller 22 (unique identification information) to be associated with each other.

FIG. 3 is a configuration diagram illustrating a table 52, this being another example of a correspondence table according to the present exemplary embodiment. FIG. 3 illustrates an example in which the identification information management section 211 acquires information from the cash processing controller 10 regarding the banknote denomination held in each of the cash holder units 11 in addition to the unique identification information 5 for the corresponding spray controller 22 and the identification information for the cash holder unit 11. As illustrated in the example in FIG. 3, the correspondence table 52 enables the identification information for each cash holder unit 11 (holder unit identification information), the unique identification information 5 for the corresponding spray controller 22 (unique identification information), and the denomination of banknotes held in the cash holder unit 11 to be associated with each other.

The state controller 212 monitors sensor signals from the sensor 12. When in a non-abnormal state of the cash processing device 1, the state controller 212 generates a control signal including a spray authorization command and performs notification through the wireless communication section 213 in order to place the relevant spray controllers 22 in the spray authorized state. This enables the relevant spray controllers 22 to be placed in the spray authorized state.

When wirelessly transmitting such a control signal, the state controller 212 references the correspondence table 51, 52 (see FIG. 2 or FIG. 3) created by the identification information management section 211, and uses the unique identification information 5 for the relevant spray controllers 22 as transmission destination addresses for wireless transmission of a signal including the control signal. Thus, even in a case in which another cash processing device 1 is located nearby, the spray controllers 22 in this other cash processing device 1 are able to disregard the wireless signal if the wireless signal is not addressed to them. This may enable accidental spraying of liquid in other cash processing devices 1 to be prevented.

In a case in which an abnormal situation has arisen and a control signal indicating a spray authorization command is to be wirelessly transmitted, the state controller 212 may reference the correspondence tables 51, 52 (see FIG. 2 or FIG. 3) in order to wirelessly transmit a control signal to the spray controllers 22 corresponding to all of the cash holder units 11 loaded in the cash processing device 1, or in order to wirelessly transmit a control signal to the spray controllers 22 corresponding to some of the cash holder units 11 loaded in the cash processing device 1.

For example, the state controller 212 may reference the correspondence table 52 in FIG. 3 to find cash holder units 11 holding banknote denominations with a high banknote value, and then wirelessly transmit a control signal indicating a spray authorization command using the unique identification information 5 serving as transmission destination addresses of the spray controllers 22 corresponding to the found cash holder units 11. This enables the spray controllers 22 of cash holder units 11 holding banknote denominations with a high banknote value to be commanded using the spray authorization command. In other words, by referencing the correspondence table 52 in FIG. 3, the state controller 212 is able to identify which banknote-holding cash holder units 11 hold banknotes configuring liquid spray targets, and to issue a spray authorization command to the spray controllers 22 corresponding to these cash holder units 11.

The wireless communication section 213 transmits a wireless signal including a control signal under the control of the state controller 212.

Sensor 12

The sensor 12 detects an attack on the cash processing device 1 when a malicious actor attempts to steal banknotes. Various sensors may be applied as the sensor 12, such as a flame cutting sensor that detects if the casing of the cash processing device 1 is being opened with a flame cutting machine, a door opening detection sensor that detects if a door behind which the cash holder units 11 are held is being opened, or a vibration sensor. One or plural sensors 12 may be provided.

(A-2) Operation of Exemplary Embodiment

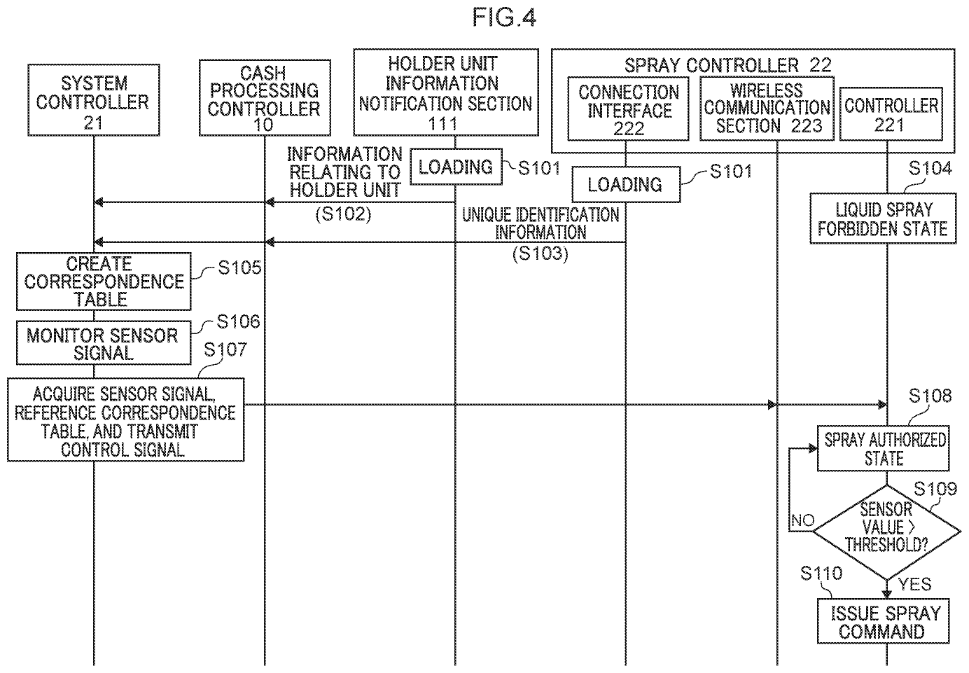

FIG. 4 is a sequence chart illustrating a processing operation of the cash processing device 1 according to the present exemplary embodiment.

S101 to S104

When a cash holder unit 11 is loaded into the cash processing device 1 (S101), the holder unit information notification section 111 of the cash holder unit 11 notifies the cash processing controller 10 of the information 111a relating to this cash holder unit 11 (S102). The system controller 21 is also notified of the information 111a relating to this cash holder unit 11 that has been notified to the cash processing controller 10.

Moreover, when a cash holder unit 11 is loaded into the cash processing device 1 (S101), the controller 221 of the spray controller 22 reads the unique identification information 5 from the memory section 224, and notifies the cash processing controller 10 of this unique identification information 5 through the connection interface 222 (S103). The system controller 21 is then notified of this unique identification information 5 for the spray controller 22 that has been notified to the cash processing controller 10. Note that at the time when the cash holder unit 11 is loaded into the cash processing device 1, or the time when the power source of the cash processing device 1 is switched ON, the corresponding spray controller 22 adopts a liquid spray forbidden state as an initial state (S104).

In the present exemplary embodiment, an example is given in which the unique identification information 5 for the spray controller 22 is identification information (ID) that is different from the identification information (holder unit identification information) for the corresponding cash holder unit 11.

Thus, at S102 and S103 in FIG. 4, the holder unit information notification section 111 of the cash holder unit 11 and the controller 221 of the spray controller 22 each separately notifies the cash processing controller 10 of the corresponding identification information (holder unit identification information or unique identification information 5).

However, in a case in which the unique identification information 5 for the spray controller 22 is the same identification information (ID) as the identification information (holder unit identification information) for the corresponding cash holder unit 11, either one out of the holder unit information notification section 111 of the cash holder unit 11 or the controller 221 of the corresponding spray controller 22 may notify the cash processing controller 10 of this identification information. This enables the cash processing controller 10 to be notified of common identification information for both the cash holder unit 11 and the corresponding spray controller 22 through a common connection interface connected to the cash processing controller 10.

S105

The system controller 21 acquires the holder unit identification information for the cash holder unit 11 and the unique identification information for the spray controller 22 provided to this cash holder unit 11 from the cash processing controller 10, and creates a correspondence table in which this holder unit identification information and unique identification information are associated with each other (S105).

Note that although an example is given here in which the system controller 21 creates the correspondence table 51 in FIG. 2, the system controller 21 may create the correspondence table in FIG. 3. Furthermore, there is no limitation to the configurations of the correspondence tables 51, 52 in FIG. 2 and FIG. 3, and the system controller 21 may coordinate with the cash processing controller 10 so as to effectively utilize the information stored in the memory section 102a and used by the cash processing controller 10 during cash processing to create a correspondence table.

S106, S107

The system controller 21 monitors sensor signals from the sensor 12 (S106). Namely, the system controller 21 acquires the sensor signal from the sensor 12, and in a non-abnormal state of the cash processing device 1, the system controller 21 references the correspondence table to read the unique identification information 5 for the respective spray controllers 22 associated with the identification information for the relevant cash holder units 11, and creates a control signal including a spray authorization command. The system controller 21 then wirelessly transmits the control signal including the spray authorization command to the relevant spray controllers 22 (S107).

Note that when wirelessly transmitting control signals to the spray controllers 22 of plural cash holder units 11 loaded into the cash processing device 1, the system controller 21 may wirelessly transmit a control signal to each of the spray controllers 22 in sequence.

S108 to S110

The respective spray controllers 22 wirelessly receive the control signal including the spray authorization command from the system controller 21.

In a case in which the unique identification information 5 of the spray controller 22 is included in the received wireless signal, the wireless communication section 223 of this spray controller 22 passes the control signal to the controller 221. In a case in which the unique identification information 5 of the spray controller 22 is not included in the wireless signal, the wireless signal is disregarded.

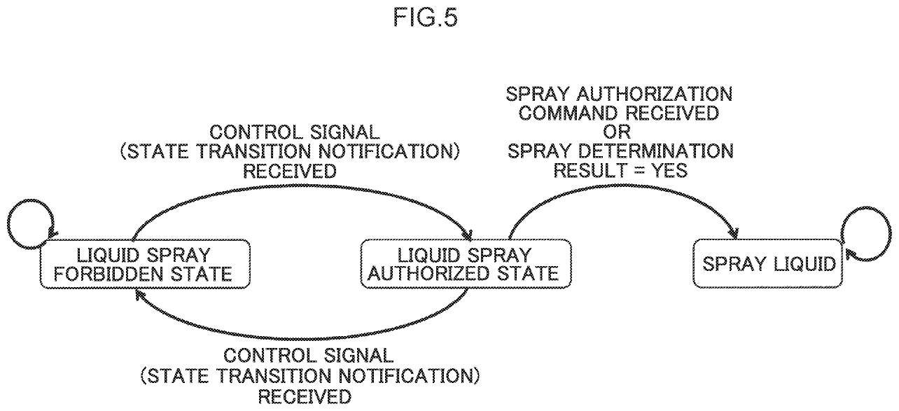

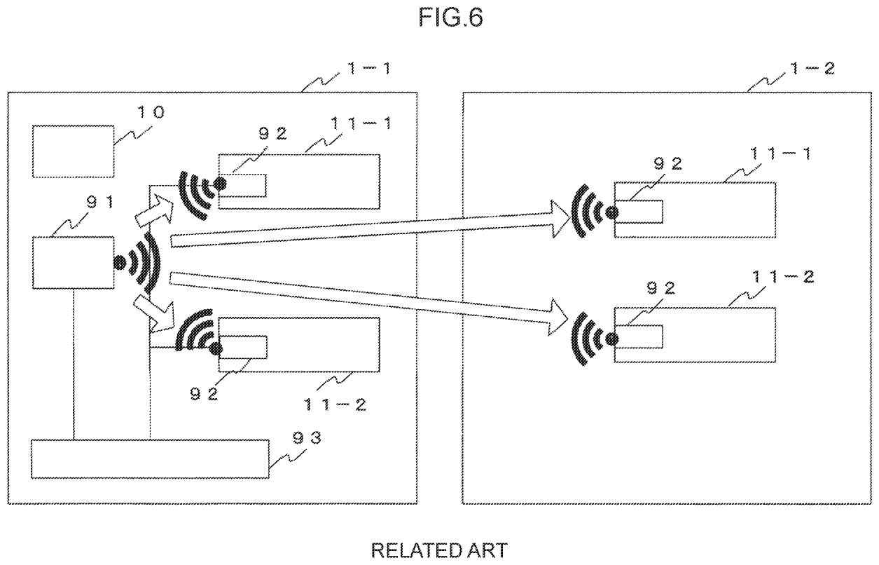

FIG. 5 is an explanatory diagram for explaining state transition in each of the spray controllers 22 according to the present exemplary embodiment.

The initial state of the spray controller 22 is a liquid spray forbidden state. When the controller 221 acquires a control signal including a spray authorization command from the system controller 21, the liquid spray controller 32 of the controller 221 transitions its own state to a liquid spray authorized state (S108).

The liquid spray controller 32 acquires a sensor signal from the sensor 12, and compares a physical quantity (expressed as “sensor value” in FIG. 4) included in the sensor signal against a threshold (S109).

In a case in which the physical quantity in the sensor signal exceeds the threshold (S109), the liquid spray controller 32 commands the liquid spray mechanism 40 to spray liquid (S110). In a case in which the physical quantity in the sensor signal is the threshold or below (S109), the liquid spray controller 32 does not issue a liquid spray command to the liquid spray mechanism 40.

Note that the threshold provided with respect to the physical quantity included in the sensor signal may be set according to the type of sensor. Moreover, one or plural thresholds may be provided according to each sensor type in order to correctly determine whether an abnormal situation has arisen. As a method of determining whether an abnormal situation has arisen in the case of a vibration sensor, an abnormal situation may be determined to have arisen in a case in which a vibration value detected by the vibration sensor has exceeded the threshold.

(A-3) Effects of Present Exemplary Embodiment

As described above, in the present exemplary embodiment, unique identification information is stored in a memory section such as non-volatile memory, the spray controller is able to notify the system controller of this unique identification information, and the system controller is able to manage the unique identification information for respective spray controllers. The system controller is accordingly able to wirelessly communicate a control signal using the unique identification information for the respective spray controller, thereby enabling accidental spraying of liquid in a nearby cash processing device to be prevented.

### (B) Other Exemplary Embodiments

Various modified exemplary embodiments of the exemplary embodiment described above have already been mentioned. The following modified exemplary embodiments may also be applied to the present disclosure.

(B-1) In the exemplary embodiment described above, an example has been given in which each of the spray controllers notifies the system controller of its unique identification information through the cash processing controller. However, if it is possible for the unique identification information for each of the spray controllers to be notified to the system controller, the unique identification information may be directly notified to the system controller by the spray controller.

For example, when a cash holder unit is loaded into the cash processing device, the corresponding spray controller may wirelessly transmit a signal including the unique identification information to the system controller. If the unique identification information is the same as the holder unit identification information, the system controller is able to recognize the unique identification information acquired from the spray controller as the holder unit identification information. Furthermore, the system controller is able to acquire information relating to each of the cash holder units from the cash processing controller, and create a correspondence table (see FIG. 3 for example) in which the unique identification information (holder unit identification information) serves as a key that is associated with this information relating to each of the cash holder units.

(B-2) The system controller uses the unique identification information as a key when creating the correspondence table. However, the configuration of the correspondence table is not limited to that illustrated in FIG. 2 or FIG. 3.

As a modified example of the correspondence table, the system controller may create a correspondence table containing associations between real time information acquired from the cash processing controller that executes cash processing, regarding the banknote denominations and the number of banknotes being held in each cash holder unit, whether each cash holder unit is full, and the like.

When an abnormal situation has arisen and a control signal including a spray authorization command is to be wirelessly transmitted, the system controller references a correspondence table such as those described above. In a case in which the cash holder units include an empty cash holder unit (i.e. a cash holder unit in which no banknotes are being held), the system controller may refrain from transmitting a control signal including a spray authorization command to the spray controller provided to this empty cash holder unit.

Spraying liquid causes the cash holder unit itself to be stained. The above example enables unnecessary spraying of liquid onto empty and other such cash holder units to be avoided.

(B-3) The cash processing device applied to the present disclosure may be applied to a wide range of devices, as long as the device is one that handles cash. For example, the present disclosure may be applied to an auto teller machine (ATM), a cash processing device that manages sales and change in a shop such as a retail store, or a back office cash processing device used in a branch of a financial institution.

(B-4) In the exemplary embodiment described above, the cash holder unit is envisaged to include a box shaped depository. However, the depository of the cash holder unit may take the form of a bag.

The disclosure of Japanese Patent Application No. 2018-237730, filed on Dec. 19, 2018 is incorporated in its entirety by reference herein.

All cited documents, patent applications, and technical standards mentioned in the present specification are incorporated by reference in the present specification to the same extent as if each individual cited document, patent application, or technical standard was specifically and individually indicated to be incorporated by reference.

1. A cash processing device comprising:
a first medium holder unit, including
a first depository,
a first liquid spray mechanism configured to spray liquid onto mediums held in the first depository, and
a first spray controller capable of reading first unique identification information associated with the first medium holder unit and configured to control operation of the first liquid spray mechanism, the first spray controller including a first wireless communication section;
a second medium holder unit, including
a second depository,
a second liquid spray mechanism configured to spray liquid onto mediums held in the second depository, and
a second spray controller capable of reading second unique identification information associated with the second medium holder unit and configured to control operation of the second liquid spray mechanism, the second spray controller including a second wireless communication section;
a sensor configured to output a detection signal;
a system controller including
a state controller that monitors a state of the cash processing device based on the detection signal, and
a third wireless communication section, wherein
the first wireless communication section is configured to pass on a wireless signal received from the third wireless communication section to the first spray controller,
the second wireless communication section configured to pass on the wireless signal received from the third wireless communication section to the second spray controller, and
the system controller is configured to
acquire the first unique identification information from the first spray controller,
acquire the second unique identification information from the second spray controller, and
use the first unique identification information or the second unique identification information to transmit a control signal relating to liquid spraying from the third wireless communication section to the first or second wireless communication section, in response to a monitoring outcome of the state controller.

2. The cash processing device of claim 1, further comprising a cash processing controller,
wherein the first spray controller and the second spray controller respectively notify the first unique identification information and the second unique identification information to the system controller through the cash processing controller.

3. The cash processing device of claim 1, wherein the first spray controller and the second spray controller respectively notify the system controller of the first unique identification information and the second unique identification information by wired communication.

4. The cash processing device of claim 2, wherein:
the system controller
acquires information relating to the first medium holder unit and information relating to the second medium holder unit from the cash processing controller, and
manages the first unique identification information to be associated with the information relating to the first medium holder unit, and
manages the second unique identification information to be associated with the information relating to the second medium holder unit; and
the state controller determines a transmission destination of the control signal according to a state of the first medium holder unit and a state of the second medium holder unit, based on the information relating to the first medium holder unit and the information relating to the second medium holder unit.

5. The cash processing device of claim 1, wherein
the first medium holder further includes a first memory section that stores the first unique identification information, and
the second medium holder further includes a second memory section that stores the second unique identification information.

6. The cash processing device of claim 1, further comprising a management section that manages the first unique identification information acquired from the first spray controller and the second unique identification information acquired from the second spray controller.

7. (canceled)

8. The cash processing device of claim 1, wherein:
the system controller acquires information relating to the first medium holder unit and information relating to the second medium holder unit; and
the state controller determines a transmission destination of the control signal according to a state of the first medium holder unit and a state of the second medium holder unit based on the information relating to the first medium holder unit and the information relating to the second medium holder unit.

9. The cash processing device of claim 8, wherein:
the information relating to the first medium holder unit indicates a type of the medium held in the first depository;
the information relating to the second medium holder unit indicates a type of the medium held in the second depository; and
the state controller determines the transmission destination of the control signal according to the type of the medium held in the first medium holder unit and in the second medium holder unit.

10. The cash processing device of claim 8, wherein:
the information relating to the first medium holder unit indicates whether or not the medium is being held in the first depository;
the information relating to the second medium holder unit indicates whether or not the medium is being held in the second depository; and
the state controller determines the transmission destination of the control signal according to whether or not the medium is being held in the first medium holder unit and the second medium holder unit.
